(19) United States
(12) Patent Application Publication
(10) Pub. No.: US 2013/0228040 A1
(43) Pub. Date: Sep. 5, 2013

(54) VARIABLE MASS FLYWHEEL

(71) Applicant: Roy Anderson, Burnaby (CA)

(72) Inventor: Roy Anderson, Burnaby (CA)

(21) Appl. No.: 13/695,772

(22) PCT Filed: May 2, 2011
(86) PCT No.: PCT/CA2011/050268

§ 371 Date: May 17, 2013

Related U.S. Application Data
(60) Provisional application No. 61/395,026, filed on May 5, 2010.
(60) Provisional application No. 61/344,143, filed on Jun. 1, 2010.
(60) Provisional application No. 61/344,141, filed on Jun. 1, 2010.
(60) Provisional application No. 61/344,169, filed on Jun. 3, 2010.
(60) Provisional application No. 61/344,319, filed on Jun. 29, 2010.
(60) Provisional application No. 61/344,318, filed on Jun. 29, 2010.
(60) Provisional application No. 61/399,357, filed on Jul. 12, 2010.
(60) Provisional application No. 61/344,629, filed on Sep. 2, 2010.
(60) Provisional application No. 61/427,206, filed on Dec. 27, 2010.

(51) Int. Cl. F16F 15/31

(52) U.S. Cl. CPC F16F 15/31
USPC 74/572.21

(57) ABSTRACT

The present invention relates to a flywheel having mass that is a function of its angular frequency. The variable mass flywheel includes: a primary flywheel having an axis of rotation; a secondary flywheel coaxial with the primary flywheel and having a mating portion that either circumscribes the primary flywheel or inscribes the primary flywheel; a friction disc radiating from the primary flywheel; a drive plate radiating from the mating portion of the secondary flywheel and lapping a portion of the friction disc; a coupler urging the friction disc and the drive plate into abutment whereby the primary flywheel and the secondary flywheel are coupled for unified rotation; a detector for detecting the angular frequency of the primary flywheel, the detector being operable to assume a first state when the angular frequency is less than a predetermined angular frequency and assume a second state when the angular frequency is greater than the predetermined angular frequency; and a decoupler responsive to the state of the detector, operable when the detector is in the second state to overcome the coupler and urge the friction disc and the drive plate out of abutment whereby the primary flywheel and the secondary flywheel are decoupled for separate rotation.

### BACKGROUND OF THE INVENTION

1. Field of the Invention

The present invention relates to flywheels. More particularly, it relates to flywheels with mass that is variable, including mass that varies as a function of the angular frequency of a flywheel. More purposively, the present invention relates to flywheels having mass that varies in amount and/or distribution so as to vary their moment of inertia.

2. Description of Related Art

A variable mass flywheel is useful for assisting an engine differently at different engine speeds, different vehicle speeds and different road traction conditions.

For example, at lower engine speeds, a heavier flywheel can contribute to improved traction, lower idle fuel consumption, and better absorption of fluctuations in engine torque. In contrast, at higher engine speeds, a lighter flywheel can contribute to better throttle response, better acceleration, and improved higher engine torque response characteristics. The tendency to lose traction decreases in higher gears and higher speeds.

While variable mass flywheels are known, they suffer from a number of disadvantages. In general, such flywheels have been large and bulky yet delicate and overly complicated. Some, for example, vary their mass using hazardous ferro fluid and electromagnets, which must be provided with electrical power.

Accordingly, what is needed is a better way to provide a variable mass flywheel.

### SUMMARY OF THE INVENTION

The present invention is directed to this need.

According to one aspect of the present invention, there is provided a variable mass flywheel having: a primary flywheel having an axis of rotation; a secondary flywheel coaxial with the primary flywheel and having a mating portion that one of circumscribes the primary flywheel and inscribes the primary flywheel; a friction disc radiating from the primary flywheel; a drive plate radiating from the mating portion of the secondary flywheel and lapping a portion of the friction disc; a coupler urging the friction disc and the drive plate into abutment whereby the primary flywheel and the secondary flywheel are coupled for unified rotation; a detector for detecting a condition that correlates with the desirability of the primary flywheel and the secondary flywheel being one of coupled and decoupled, the detector being operable to assume a first state when the condition is within a first range and assume a second state when the condition is within a second range; and a decoupler responsive to the state of the detector, operable when the detector is in the second state to overcome the coupler and urge the friction disc and the drive plate out of abutment whereby the primary flywheel and the secondary flywheel are decoupled for separate rotation.

The condition might be the angular frequency of the primary flywheel, such that the detector is operable to assume the first state when the angular frequency is less than a predetermined angular frequency and assume the second state when the angular frequency is greater than the predetermined angular frequency.

The friction disc and the drive plate might be an interleaved plurality of friction discs and plurality of drive plates.

The coupler might include a spring compressed between the primary flywheel and the friction disc.

The flywheel might include a pressure plate between the spring and the friction disc.

The detector might include: a ramp radiating outward on the primary flywheel, the ramp having a base and an apex, the apex being radially farther than the base from the axis of rotation; and a mass captive on the ramp and operable to move along the ramp between the base and the apex, wherein the mass moves proximate the base when the angular frequency of the primary flywheel is less than the predetermined angular frequency, whereby the detector assumes the first state and moves proximate the apex when the angular frequency of the primary flywheel is greater than the predetermined angular frequency whereby the detector assumes the second state.

The decoupler might include: a wedge radiating outward on the pressure plate and opposing the ramp, the wedge having a toe and a heel, the heel being radially farther than the toe from the axis of rotation, the wedge sloping toward the ramp from toe to heel; and a bearing circumscribing the mass and operable to move along the wedge between the toe and the heel as the mass moves along the ramp between the base and the apex, wherein the bearing moves proximate the toe when the detector assumes the first state and moves proximate the heel when the detector assumes the second state, thereby bearing on the pressure plate to overcome the coupler and urge the friction disc and the drive plate out of abutment whereby the primary flywheel and the secondary flywheel are decoupled for separate rotation.

The mass may be an axle having a first end and a second end. The ramp may be bifurcated by a channel into a first ramp and a second ramp, wherein the first end of the axle is captive on the first ramp and the second end of the axle is captive on the second ramp. The channel may receive the bearing. The bearing may be a rolling-element bearing.

The ramp may slope from the base to the apex toward the wedge.

The flywheel may further include a plurality of the detector and a plurality of the decoupler distributed about the primary flywheel.

According to another aspect of the present invention, there is provided an actuator having: a body having an axis of rotation; a pressure plate coaxial with the body; a coupler urging the pressure plate toward the body; a ramp radiating outward on the body, the ramp having a base and an apex, the apex being radially farther than the base from the axis of rotation; a mass captive on the ramp and operable to move along the ramp between the base and the apex, wherein the mass moves proximate the base when the angular frequency of the body is less than a predetermined angular frequency and moves proximate the apex when the angular frequency of the body is greater than the predetermined angular frequency; a wedge radiating outward on the pressure plate and opposing the ramp, the wedge having a toe and a heel, the heel being radially farther than the toe from the axis of rotation, the wedge sloping toward the ramp from toe to heel; and a bearing circumscribing the mass and operable to move along the wedge between the toe and the heel as the mass moves along the ramp between the base and the apex, wherein the bearing at the heel bears upon the pressure plate to overcome the coupler and urge the pressure plate away from the body.

The mass may be an axle having a first end and a second end.

The ramp may be bifurcated by a channel into a first ramp and a second ramp, wherein the first end of the axle is captive on the first ramp and the second end of the axle is captive on the second ramp. The channel may receive the bearing. The bearing may be a rolling-element bearing.

The ramp may slope from the base to the apex toward the wedge.

Further aspects and advantages of the present invention will become apparent upon considering the following drawings, description, and claims.

### DESCRIPTION OF THE INVENTION

The invention will be more fully illustrated by the following detailed description of non-limiting specific embodiments in conjunction with the accompanying drawing figures. In the figures, similar elements and/or features may have the same reference label. Further, various elements of the same type may be distinguished by following the reference label with a second label that distinguishes among the similar elements. If only the first reference label is identified in a particular passage of the detailed description, then that passage describes any one of the similar elements having the same first reference label irrespective of the second reference label.

### BRIEF DESCRIPTION OF THE DRAWINGS

FIG. 1 is a cross-section view of a first embodiment of a variable mass flywheel according to aspects of the present invention, the variable mass flywheel including a primary flywheel and a secondary flywheel (not shown in this view for clarity).

FIG. 2 is a radial-section view of the variable mass flywheel of FIG. 1, along the cutting plane 2-2, FIG. 2a with the primary flywheel at low angular frequency and FIG. 2b with the primary flywheel at high angular frequency, the top half of the view depicting a decoupler and the bottom half of the view suppressing a decoupler to better depict surrounding elements.

FIG. 3 is a radial-section view of the variable mass flywheel of FIG. 1, along the cutting plane 3-3, FIG. 3a with the primary flywheel at low angular frequency and FIG. 3b with the primary flywheel at high angular frequency.

FIG. 4 is a radial-section view of a second embodiment of a variable mass flywheel according to aspects of the present invention, the variable mass flywheel including a primary flywheel and a secondary flywheel, FIG. 4a with the primary flywheel at low angular frequency and FIG. 4b with the primary flywheel at high angular frequency, the top half of the view depicting a detector/decoupler and the bottom half of the view suppressing a detector/decoupler to better depict surrounding elements.

FIG. 5 is a cross-section view of a third embodiment of a variable mass flywheel according to aspects of the present invention, the variable mass flywheel including a primary flywheel and a secondary flywheel (not shown in this view for clarity).

FIG. 6 is a radial-section view of the variable mass flywheel of FIG. 5, along the cutting plane 6-6, FIG. 6a with the primary flywheel at low angular frequency and FIG. 6b with the primary flywheel at high angular frequency.

FIG. 7 is a radial-section view of the variable mass flywheel of FIG. 5, along the cutting plane 7-7, FIG. 7a with the primary flywheel at low angular frequency and FIG. 7b with the primary flywheel at high angular frequency.

FIG. 8 is a radial-section view of a fourth embodiment of a variable mass flywheel according to aspects of the present invention, the variable mass flywheel including a primary flywheel and a secondary flywheel, FIG. 8a depicting high hydraulic pressure and FIG. 8b depicting low hydraulic pressure.

FIG. 9 is a radial-section view of a fifth embodiment of a variable mass flywheel according to aspects of the present invention, the variable mass flywheel including a primary flywheel and a secondary flywheel, FIG. 9a depicting low hydraulic pressure and FIG. 9b depicting high hydraulic pressure.

FIG. 10 is a radial-section view of a sixth embodiment of a variable mass flywheel according to aspects of the present invention, the variable mass flywheel including a primary flywheel and a secondary flywheel, FIG. 10a depicting low hydraulic pressure and FIG. 10b depicting high hydraulic pressure.

FIG. 11 is a radial-section view of a seventh embodiment of a variable mass flywheel according to aspects of the present invention, the variable mass flywheel including a primary flywheel and a secondary flywheel, FIG. 11a depicting high vacuum (or low pneumatic pressure) and FIG. 11b depicting low vacuum (or high pneumatic pressure).

FIG. 12 is a radial-section view of a eighth embodiment of a variable mass flywheel according to aspects of the present invention, the variable mass flywheel including a primary flywheel and a secondary flywheel, FIG. 12a with the primary flywheel at low angular frequency and FIG. 12b with the primary flywheel at high angular frequency.

### DETAILED DESCRIPTION OF SPECIFIC EMBODIMENTS

The structure and operation of aspects of the invention will now be illustrated by explanation of one general approach and descriptions of eight specific embodiments shown in the drawing figures and described in greater detail herein. These illustrations, explanations and descriptions are only exemplary and are not to be interpreted as limiting the scope of the invention, which is defined in the claims.

### A General Approach

Referring to all of the Figures, a variable mass flywheel 100 can be provided according to aspects of the present invention, as a combination of: a primary flywheel 102 having an axis of rotation; a secondary flywheel 104 coaxial with the primary flywheel 102 and having a mating portion 106 that one of: circumscribes the primary flywheel 102, and inscribes the primary flywheel 102; a friction disc 108 radiating from the primary flywheel 102; a drive plate 110 radiating from the mating portion 106 of the secondary flywheel 104 and lapping a portion of the friction disc 108; a coupler 112 urging the friction disc 108 and the drive plate 110 into abutment whereby the primary flywheel 102 and the secondary flywheel 104 are coupled for unified rotation; a detector 114 for detecting the angular frequency of the primary flywheel 102, the detector 114 being operable to: assume a first state when the angular frequency is less than a predetermined angular frequency, and assume a second state when the angular frequency is greater than the predetermined angular frequency; and a decoupler 116 responsive to the state of the detector 114, operable when the detector 114 is in the second state to overcome the coupler 112 and urge the friction disc 108 and the drive plate 110 out of abutment whereby the primary flywheel 102 and the secondary flywheel 104 are decoupled for separate rotation.

Teachings of the present invention can be applied more generally to provide an actuator 101 as a combination of: a body 102 having an axis of rotation; a pressure plate 118 coaxial with the body 102; a coupler 112 urging the pressure plate 118 toward the body 102; a ramp 120 radiating outward on the body 102, the ramp 120 having a base 122 and an apex 124, the apex 124 being radially farther than the base 122 from the axis of rotation; a mass 126 captive on the ramp 120 and operable to move along the ramp 120 between the base 122 and the apex 124, such that the mass 126 moves proximate the base 122 when the angular frequency of the body 102 is less than a predetermined angular frequency and moves proximate the apex 124 when the angular frequency of the body is greater than the predetermined angular frequency; a wedge 128 radiating outward on the pressure plate 118 and opposing the ramp 120, the wedge 128 having a toe 130 and a heel 132, the heel 132 being radially farther than the toe 130 from the axis of rotation, the wedge 128 sloping toward the ramp 120 from toe 130 to heel 132; and a bearing 134 circumscribing the mass 126 and operable to move along the wedge 128 between the toe 130 and the heel 132 as the mass 126 moves along the ramp 120 between the base 122 and the apex 124, such that the bearing 134 at the heel 132 bears upon the pressure plate 118 to overcome the coupler 112 and urge the pressure plate 118 away from the body 102.

In general terms, when the variable mass flywheel 100 rotates within a higher range of angular frequencies it has the mass of only the primary flywheel 102 and when the variable mass flywheel 100 rotates within a lower range of angular frequencies it has the combined mass of both the primary flywheel 102 and the secondary flywheel 104.

More particularly, the coupler 112 urges the friction disc 108 and the drive plate 110 into abutment when the variable mass flywheel 100 rotates at an angular frequency below a predetermined angular frequency, whereby the primary flywheel 102 and the secondary flywheel 104 are coupled for unified rotation. In opposition, the decoupler 116 overcomes the coupler 112 and urges the friction disc 108 and the drive plate 110 out of abutment when the variable mass flywheel 100 rotates at an angular frequency above the predetermined angular frequency, whereby the primary flywheel 102 and the secondary flywheel 104 are decoupled for separate rotation.

Thus it will be seen that the coupler 112 acts continuously to couple the primary flywheel 102 and the secondary flywheel 104, but the decoupler 116 acts and overcomes the coupler 112 only when the variable mass flywheel 100 rotates at an angular frequency above the predetermined angular frequency.

In this regard, the decoupler 116 is responsive to the detector 114 for detecting the angular frequency of the primary flywheel 102, the detector 114 being operable to: assume a first state when the angular frequency is less than a predetermined angular frequency, and assume a second state when the angular frequency is greater than the predetermined angular frequency. The decoupler 116 is responsive to the state of the detector 114, operable when the detector 114 is in the second state to overcome the coupler 112 and urge the friction disc 108 and the drive plate 110 out of abutment whereby the primary flywheel 102 and the secondary flywheel 104 are decoupled for separate rotation.

The predetermined angular frequency can be adjusted by adjusting any of the detector 114, the coupler 112 and the decoupler 116. For example, the detector 114 could be adjusted to change state at a different predetermined angular frequency. As another example, the strength of the coupler 112 and the decoupler 116 could be adjusted to change respectively the force at which the decoupler 116 overcomes the coupler 112 and the force which the decoupler applies to overcome the coupler 112.

### (i) First Embodiment (Roller Bearing on Axle)

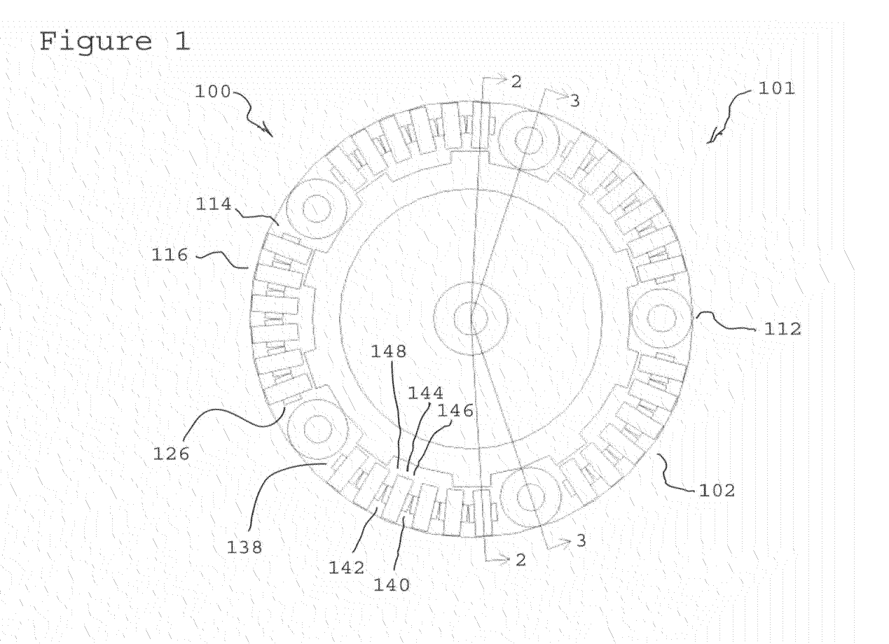

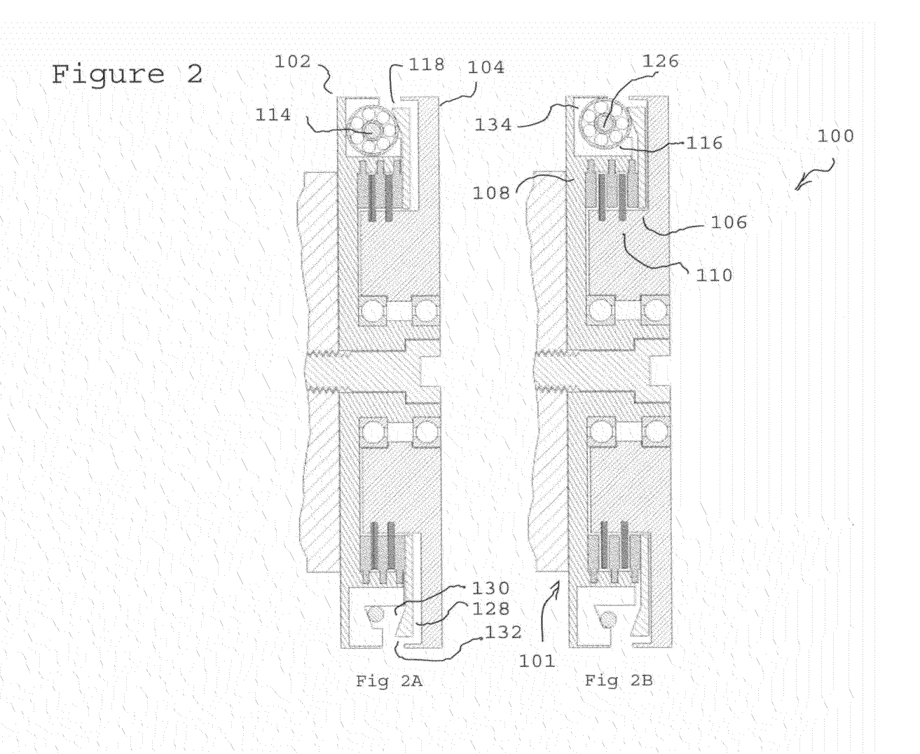

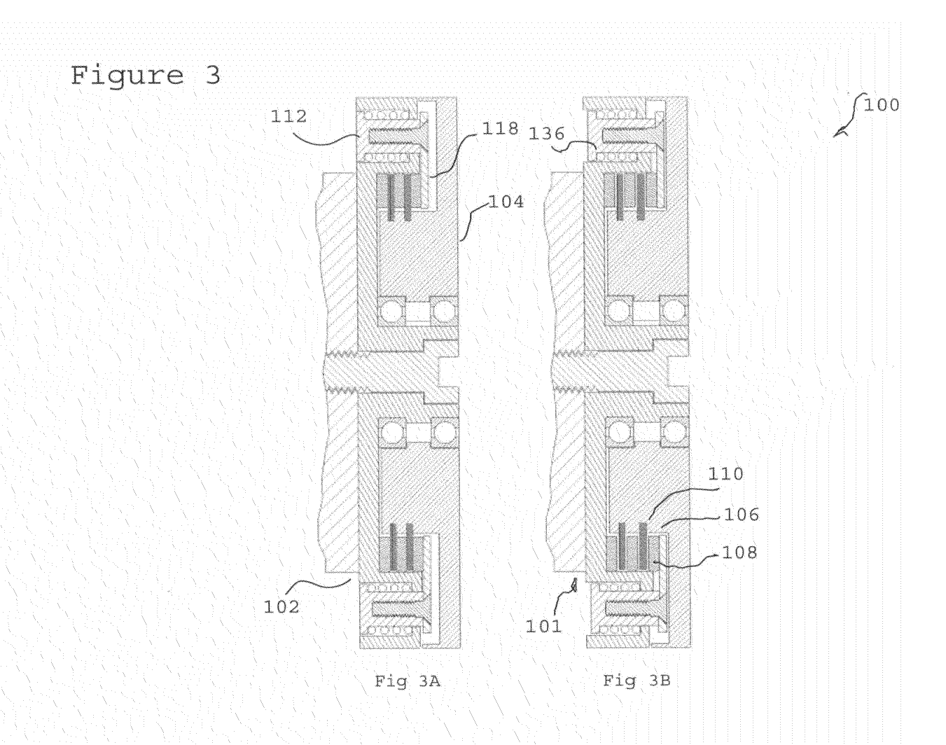

FIGS. 1-3 show a first embodiment of the variable mass flywheel 100 and the actuator 101 in accordance with aspects of the present invention.

The friction disc 108 and the drive plate 110 are embodied as an interleaved plurality of friction discs 108 and plurality of drive plates 110 to provided further abutment surfaces. The coupler 112 is embodied as a spring 136 compressed between the primary flywheel 102 and the friction disc 108, and more specifically, there is a pressure plate 118 between the spring 136 and the friction disc 108 to distribute the pressure.

The detector 114 is embodied by combining the ramp 120 (which radiates outward on the primary flywheel 102 and spans the base 122 and the apex 124, the apex 124 being radially farther than the base 122 from the axis of rotation) and the mass 126, which is captive on the ramp 120 to move along the ramp 120 between the base 122 and the apex 124, so that the mass 126 moves proximate the base 122 when the angular frequency of the primary flywheel 102 is less than the predetermined angular frequency, such that the detector 114 assumes the first state, and moves proximate the apex 124 when the angular frequency of the primary flywheel 102 is greater than the predetermined angular frequency such that the detector 114 assumes the second state.

The decoupler 116 is embodied by combining the wedge 128 (which radiates outward on the pressure plate 118 opposing the ramp 120 and spans the toe 130 and the heel 132, the heel 132 being radially farther than the toe 130 from the axis of rotation, the wedge 128 sloping toward the ramp 120 from toe 130 to heel 132) and the bearing 134, which circumscribes the mass 126 and is operable to move along the wedge 128 between the toe 130 and the heel 132 as the mass 126 moves along the ramp 120 between the base 122 and the apex 124, so that the bearing 134 moves proximate the toe 130 when the detector 114 assumes the first state, and moves proximate the heel 132 when the detector 114 assumes the second state, in this way bearing on the pressure plate 118 to overcome the coupler 112 and urge the friction disc 108 and the drive plate 110 out of abutment whereby the primary flywheel 102 and the secondary flywheel 104 are decoupled for separate rotation.

In this embodiment, the mass 126 is an axle 138 having an axle first end 140 and an axle second end 142. The ramp 120 slopes from the base 122 to the apex 124 toward the wedge 128 and is bifurcated by a channel 144 into a first ramp 146 and a second ramp 148, such that the axle first end 140 is captive on the first ramp 146 and the axle second end 142 is captive on the second ramp 148. In this way, the channel 144 can receive the bearing 134, which in this embodiment is a rolling-element bearing.

It will be seen that this embodiment of the variable mass flywheel has a plurality of the detectors 114 and a plurality of the decouplers 116 distributed about the primary flywheel 102 for more dispersed and balanced operation.

In steady state (when the primary flywheel 102 has less than the predetermined angular frequency and thus the detector 114 is in the first state), the spring 136 of the coupler 112 is compressed between the primary flywheel 102 and the pressure plate 118 to couple the friction disc 108 and the drive plate 110 and hence the primary flywheel 102 and the secondary flywheel 104.

The mass 126 of the detector 114 moves along the ramp 120 between the base 122 and the apex 124, so that the mass 126 moves proximate the base 122 when the angular frequency of the primary flywheel 102 is less than the predetermined angular frequency, such that the detector 114 assumes the first state, and moves proximate the apex 124 when the angular frequency of the primary flywheel 102 is greater than the predetermined angular frequency such that the detector 114 assumes the second state.

The bearing 134 of the decoupler 116 moves along the wedge 128 between the toe 130 and the heel 132 as the mass 126 moves along the ramp 120 between the base 122 and the apex 124, so that the bearing 134 moves proximate the toe 130 when the detector 114 assumes the first state, and moves proximate the heel 132 when the detector 114 assumes the second state, in this way bearing on the pressure plate 118 to overcome the coupler 112 and urge the friction disc 108 and the drive plate 110 out of abutment whereby the primary flywheel 102 and the secondary flywheel 104 are decoupled for separate rotation.

The predetermined angular frequency can be adjusted in a number of ways, some by way of design choices and some by way of tuning. The force of the coupler 112 that must be overcome for decoupling can be adjusted, for example, by increasing or decreasing the number of couplers 112 (either during design and manufacture, or ad hoc during operation by using less than the manufactured number of couplers 112). The force of the coupler 112 can also be adjusted by using weaker or stronger springs or adjusting the tension of the springs. The force that the decoupler 116 can apply can be adjusted by increasing or decreasing the number of decouplers 116 (either during design and manufacture, or ad hoc during operation by using less than the manufactured number of decouplers 116). The force of the decoupler 116 can also be adjusted by changing its mass, radius and spatial relation to the mass 126 of the detector 114. The responsiveness of the detector 114 to angular frequency can be adjusted by adjusting the mass of the mass 126 and the incline of the ramp 120.

Those skilled in the art will recognize that hysteresis is usually desirable in a system such as this, so that the detector 114 doesn't oscillate between the first state and the second state when the angular frequency of the primary flywheel 102 is at or near the predetermined angular frequency. Hysteresis can be increased by increasing the length of the ramp 120 and decreased by decreasing the length of the ramp 120. Changing the length of the ramp 120 leads to a change in angle for the ramp 120, which must be balanced, for example by adjusting the strength of the springs 136 or adjusting the number of or spacing between the friction discs 108 and the drive plates 110.

### (ii) Second Embodiment (Ball Bearing and Square Wedge)

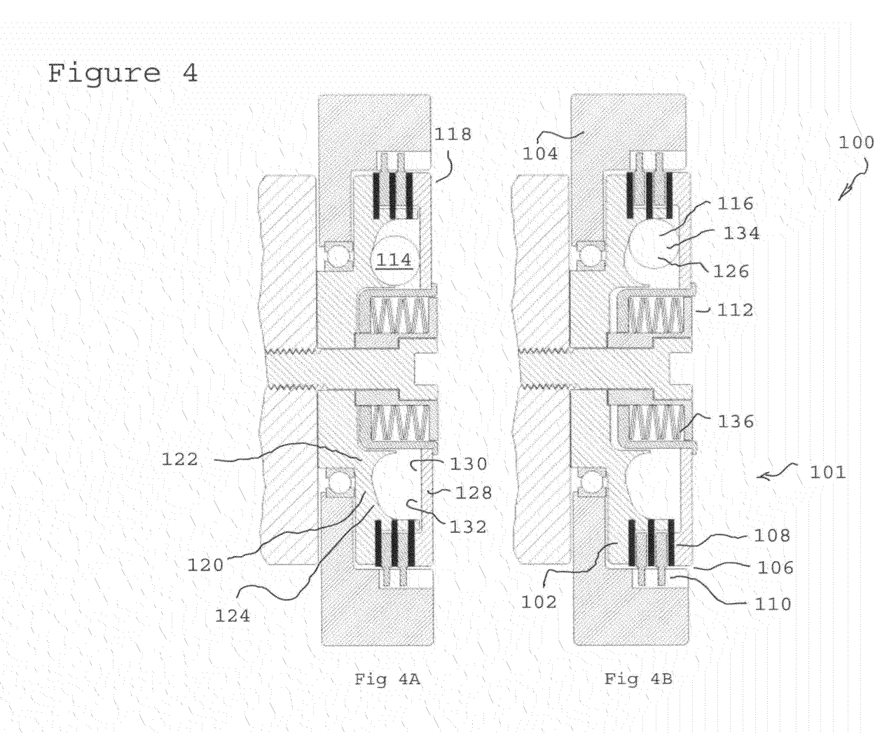

FIG. 4 shows a second embodiment of the variable mass flywheel 100 in accordance with aspects of the present invention.

In this embodiment, the detector 114 and the decoupler 116 are combined, more particularly, the mass 126 and the bearing 134 are embodied jointly as a single ball bearing 126/134; however, otherwise the second embodiment operates similarly to the first.

The ball bearing 126/134 moves along the ramp 120 between the base 122 and the apex 124, so that the ball bearing 126/134 moves proximate the base 122 when the angular frequency of the primary flywheel 102 is less than the predetermined angular frequency, such that the detector 114 assumes the first state, and moves proximate the apex 124 when the angular frequency of the primary flywheel 102 is greater than the predetermined angular frequency such that the detector 114 assumes the second state.

As a result, the ball bearing 126/134 simultaneously moves along the wedge 128 between the toe 130 and the heel 132, so that the bearing 134 moves proximate the toe 130 when the detector 114 assumes the first state, and moves proximate the heel 132 when the detector 114 assumes the second state, in this way bearing on the pressure plate 118 to overcome the coupler 112 and urge the friction disc 108 and the drive plate 110 out of abutment whereby the primary flywheel 102 and the secondary flywheel 104 are decoupled for separate rotation.

Advantageously, this second embodiment is structurally simpler than the first embodiment; however, one benefit of the first embodiment is that the distinct mass 126 and bearing 134 tested less prone to becoming lodged at the apex 124 of the ramp 120 and the heel 132 of the wedge 128 respectively, than did the combined mass 126 and bearing 134.

### (iii) Third Embodiment (Ball Bearing and Sloped Wedge)

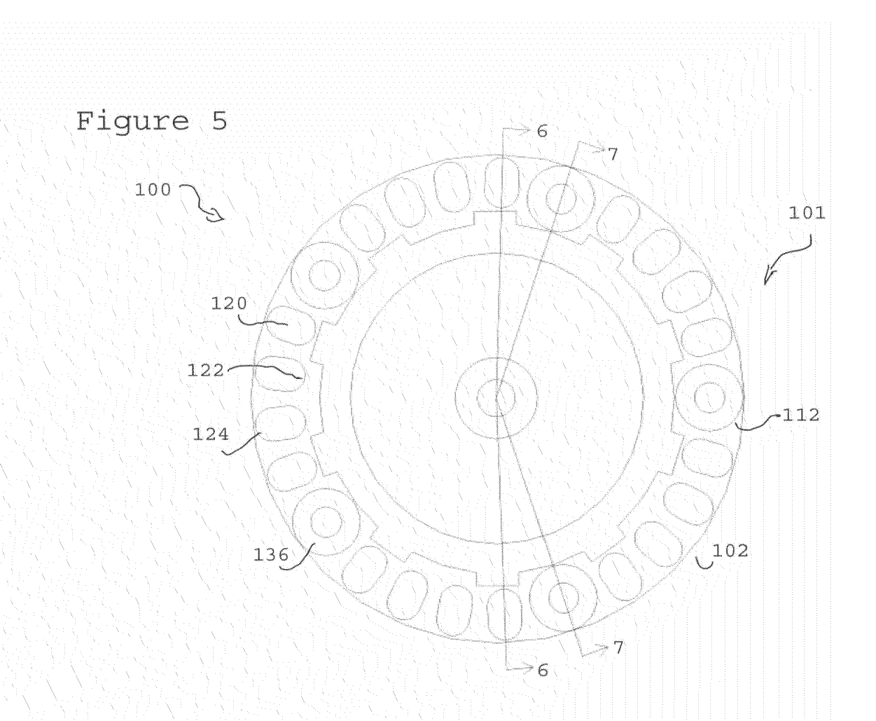

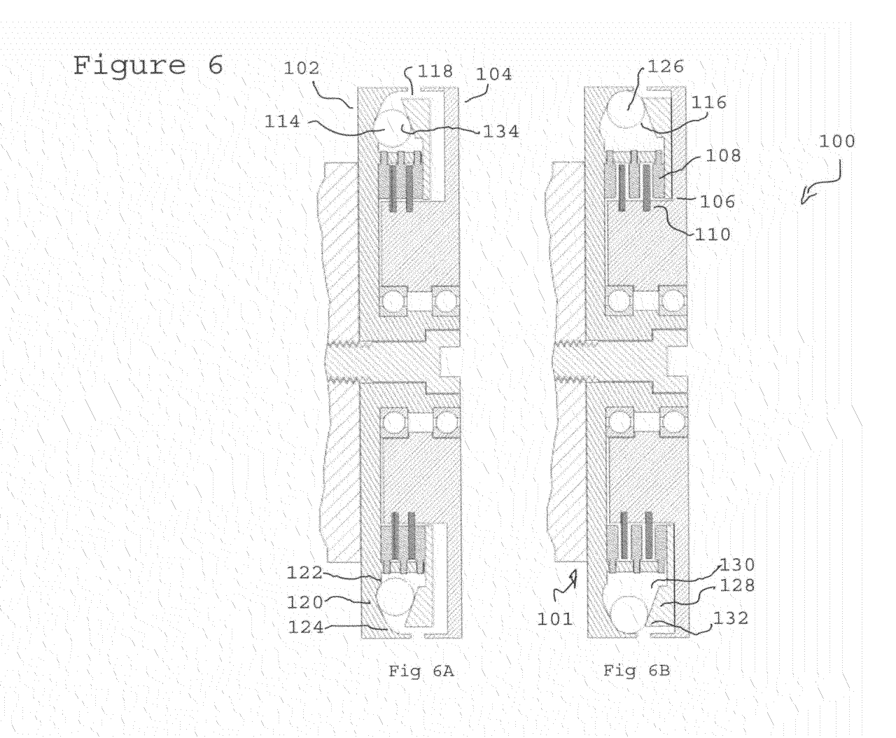

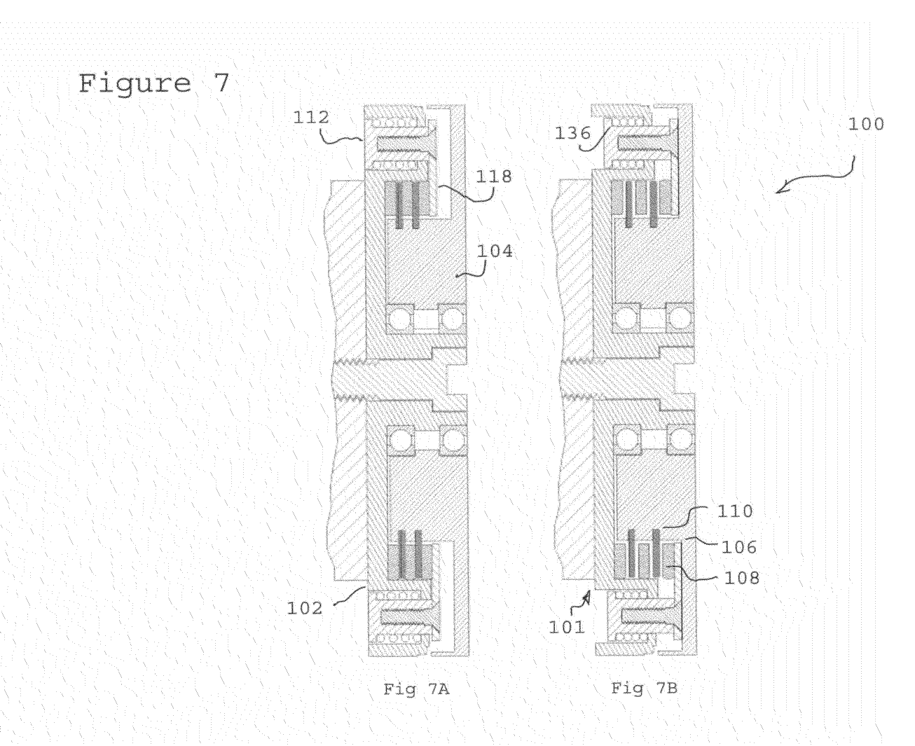

FIG. 5-7 show a third embodiment of the variable mass flywheel 100 in accordance with aspects of the present invention.

In this embodiment, the detector 114 and the decoupler 116 are combined. More particularly, the mass 126 and the bearing 134 are embodied jointly as a single ball bearing.

The third embodiment is structurally and operationally similar to the second embodiment except that in the third embodiment the wedge 128 slopes toward the ramp 120 from toe 130 to heel 132 instead of being square as in the second embodiment. Sloping the wedge 128 is yet another way to adjust the predetermined angular frequency.

### (iv) Fourth Embodiment (Hydraulic Piston—High Pressure Coupling)

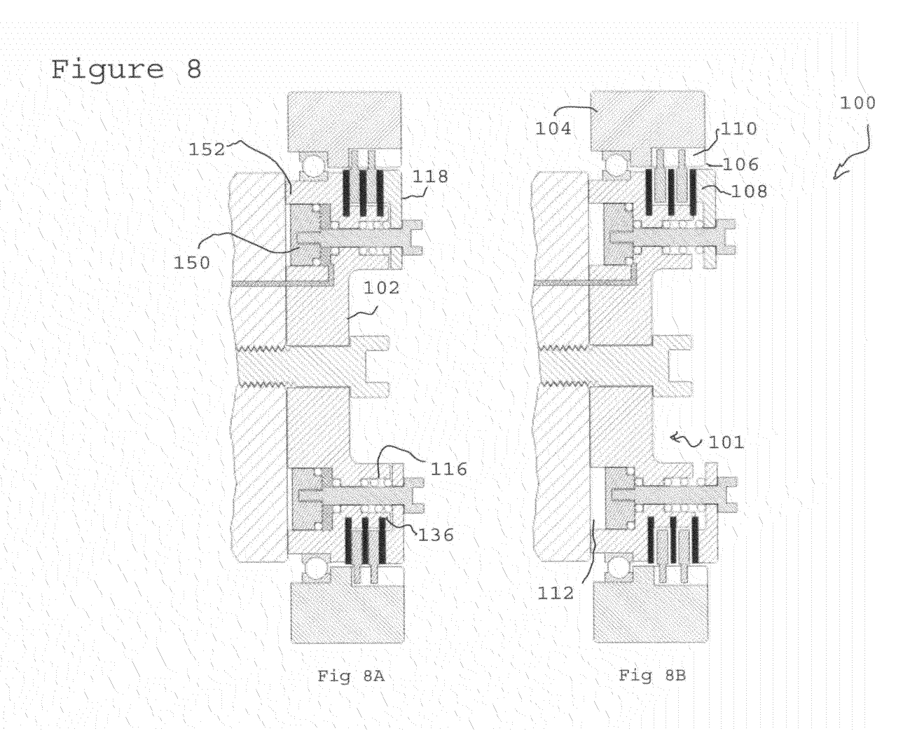

FIG. 8 shows a fourth embodiment of the variable mass flywheel 100 in accordance with aspects of the present invention.

In this embodiment, the decoupler 116 is hydraulic and the detector (not shown) is embodied so as to drive the hydraulic decoupler 116. The detector (not shown) might detect a condition that correlates with the desirability of the primary flywheel 102 and the secondary flywheel 104 being one of coupled and decoupled, the detector (not shown) assuming a first state when the condition is within a first range and assuming a second state when the condition is within a second range. For example the detector (not shown) might include a sensor (not shown) for detecting ambient temperature, precipitation, pavement condition, gear selection or wheel slip (for example as measured by comparing wheel speed to vehicle speed). Alternatively, the detector (not shown) might include a simple manual control by which a user could indicate which of the first state and the second state the detector (not shown) should assume in response to the user's assessment of such conditions.

In this regard, the detector (not shown) might include a rotary encoder (not shown) and related circuitry (not shown) to detect the angular frequency of the primary flywheel 102 and whether angular frequency of the primary flywheel 102 is greater than or less than the predetermined angular frequency. The hydraulic decoupler 116 might include a piston 150 slidable within a housing 152 within the primary flywheel 102, in this embodiment a spring-biased piston 150, actuated by a hydraulic pressure controller, for example implemented with a hydraulic pump (not shown) or a valve (not shown) for controlling access with a hydraulic fluid source/sink (not shown), which is responsive to the detector (not shown). Those skilled in the art will appreciate that this spring-biased piston 150 also forms part of the coupler 112.

In steady state (when the primary flywheel 102 has less than the predetermined angular frequency and thus the detector (not shown) is in the first state), the hydraulic pressure controller (not shown) pressurizes the hydraulic fluid in the spring-biased piston 150 to urge against the spring-bias and urge the friction disc 108 and the drive plate 110 together. When the primary flywheel 102 has more than the predetermined angular frequency and the detector (not shown) is in the second state, the hydraulic pressure controller (not shown) depressurizes the hydraulic fluid in the spring-biased piston 150 such that the spring-bias urges the friction disc 108 and the drive plate 110 apart.

In this embodiment, the predetermined angular frequency can be adjusted by calibrating the detector (not shown), for example a rotary encoder (not shown) and related circuitry (not shown). The force of the coupler 112 can be adjusted by adjusting the hydraulic properties of the spring-biased piston 150 and the hydraulic pressure controller (not shown). The force of the decoupler 116 can be adjusted by adjusting the spring-biasing of the spring-biased piston 150.

### (v) Fifth Embodiment (Hydraulic Piston—Low Pressure Coupling)

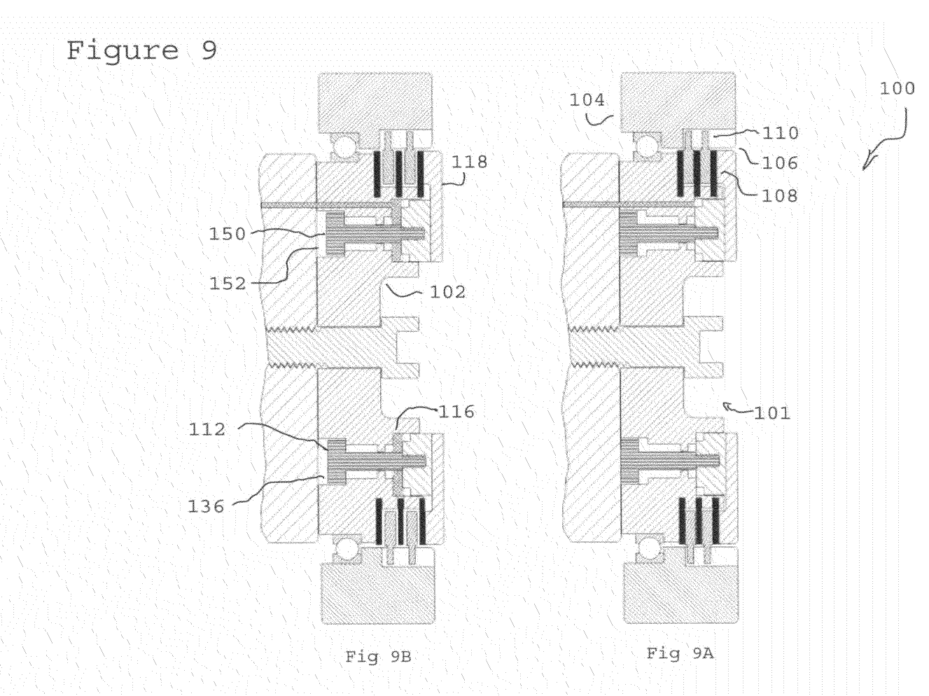

FIG. 9 shows a fifth embodiment of the variable mass flywheel 100 in accordance with aspects of the present invention.

The fifth embodiment is similar to the fourth, except that the biasing of the piston 150 is reversed.

In steady state (when the primary flywheel 102 has less than the predetermined angular frequency and thus the detector (not shown) is in the first state), the hydraulic pressure controller (not shown) depressurizes the hydraulic fluid in the spring-biased piston 150 such that the spring-bias urges the friction disc 108 and the drive plate 110 together. When the primary flywheel 102 has more than the predetermined angular frequency and the detector (not shown) is in the second state, the hydraulic pressure controller (not shown) pressurizes the hydraulic fluid in the spring-biased piston 150 to urge against the spring-bias and urge the friction disc 108 and the drive plate 110 apart.

An advantage of the fifth embodiment is that in steady state, with the primary flywheel 102 having an angular frequency below the predetermined angular frequency (including zero angular frequency), the friction disc 108 and the drive plate 110 are urged together by the spring-bias of the spring-biased piston 150, without the need for the hydraulic fluid to be maintained pressurized.

In this embodiment, the predetermined angular frequency can be adjusted by calibrating the detector (not shown), for example a rotary encoder (not shown) and related circuitry (not shown). The force of the coupler 112 can be adjusted by adjusting the hydraulic properties of the spring-biased piston 150 and the hydraulic pressure controller (not shown). The force of the decoupler 116 can be adjusted by adjusting the spring-biasing of the spring-biased piston 150.

### (vi) Sixth Embodiment (Annular Hydraulic Piston)

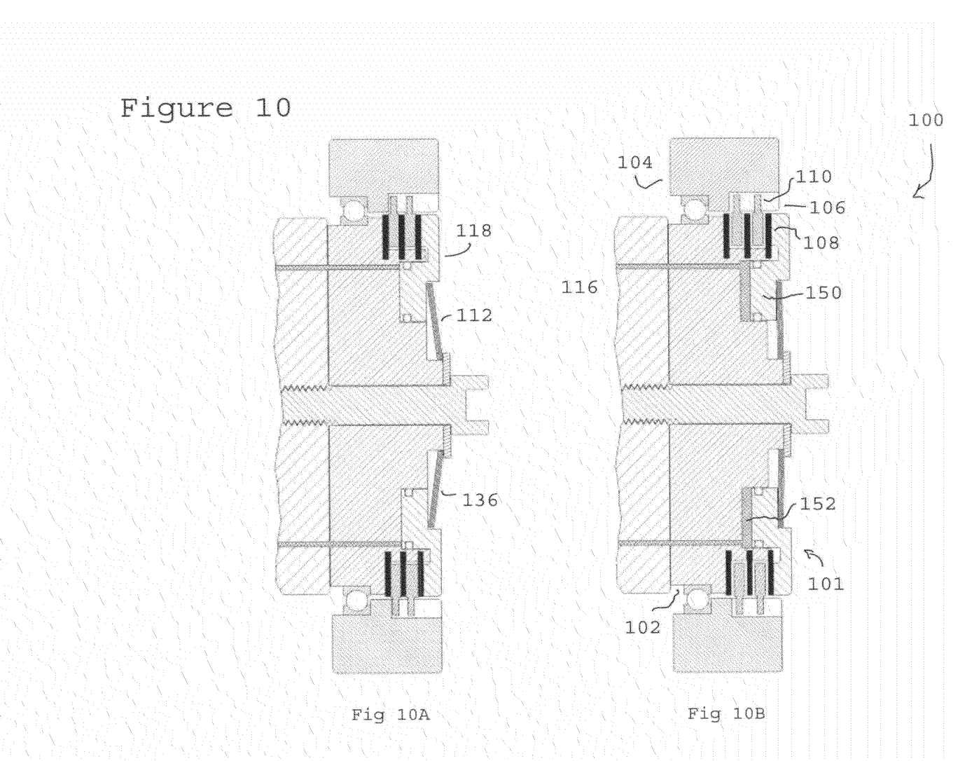

FIG. 10 shows a sixth embodiment of the variable mass flywheel 100 in accordance with aspects of the present invention.

In this embodiment, the decoupler 116 is hydraulic and the detector (not shown) is embodied so as to drive the hydraulic decoupler 116. However, unlike the fourth and fifth embodiments, in this sixth embodiment the spring-biased piston 150 is annular and integrated with the pressure plate 118.

In steady state (when the primary flywheel 102 has less than the predetermined angular frequency and thus the detector (not shown) is in the first state), the hydraulic pressure controller (not shown) depressurizes the hydraulic fluid in the spring-biased piston 150 such that the spring-bias urges the friction disc 108 and the drive plate 110 together. When the primary flywheel 102 has more than the predetermined angular frequency and the detector (not shown) is in the second state, the hydraulic pressure controller (not shown) pressurizes the hydraulic fluid in the spring-biased piston 150 to urge against the spring-bias and urge the friction disc 108 and the drive plate 110 apart.

This sixth embodiment operates quite similarly to the fifth embodiment; however, the hydraulic pressure is distributed fully annularly about the pressure plate instead of at multiple discrete pistons 150 as in the fifth embodiment.

### (vii) Seventh Embodiment (Pneumatic Piston)

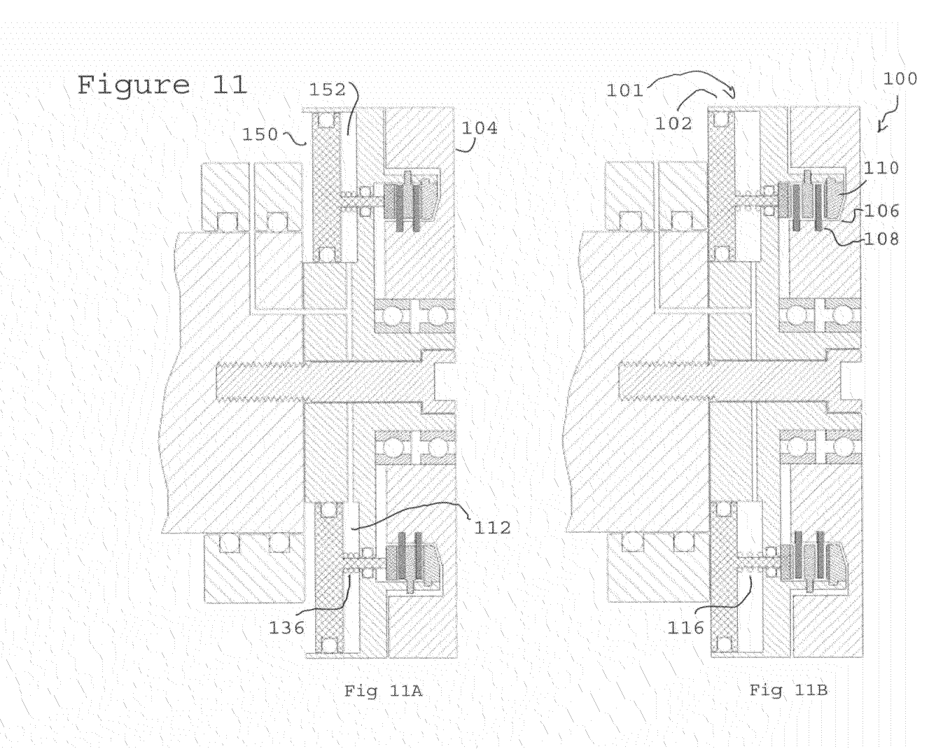

FIG. 11 shows a seventh embodiment of the variable mass flywheel 100 in accordance with aspects of the present invention.

In this embodiment, the decoupler 116 is pneumatic and the detector (not shown) is embodied so as to drive the pneumatic decoupler 116. The detector (not shown) might detect a condition that correlates with the desirability of the primary flywheel 102 and the secondary flywheel 104 being one of coupled and decoupled, the detector (not shown) assuming a first state when the condition is within a first range and assuming a second state when the condition is within a second range. For example the detector (not shown) might include a sensor (not shown) for detecting ambient temperature, precipitation, pavement condition, gear selection or wheel slip (for example as measured by comparing wheel speed to vehicle speed). Alternatively, the detector (not shown) might include a simple manual control by which a user could indicate which of the first state and the second state the detector (not shown) should assume in response to the user's assessment of such conditions.

In this regard, the detector (not shown) might include a rotary encoder (not shown) and related circuitry (not shown) to detect the angular frequency of the primary flywheel 102 and whether angular frequency of the primary flywheel 102 is greater than or less than the predetermined angular frequency.

The pneumatic decoupler 116 might include a piston 150 slidable within a housing 152 within the primary flywheel 102, in this embodiment a spring-biased annular piston 150 slidable within an annular housing 152 and actuated by a vacuum controller, for example implemented with a vacuum pump (not shown) or a valve (not shown) for controlling access with a vacuum source/sink (not shown) such as an engine intake, that is responsive to the detector (not shown). Those skilled in the art will appreciate that this spring-biased piston 150 also forms part of the coupler 112.

In steady state (when the primary flywheel 102 has less than the predetermined angular frequency and thus the detector (not shown) is in the first state), the vacuum controller (not shown) evacuates the housing 152 around the spring-biased piston 150 to urge the piston 150 against the spring-bias and urge the friction disc 108 and the drive plate 110 together.

When the primary flywheel 102 has more than the predetermined angular frequency and the detector (not shown) is in the second state, the vacuum controller (not shown) allows the housing 152 to repressurize to atmospheric pressure such that the spring-bias on the piston 150 urges the friction disc 108 and the drive plate 110 apart.

### (viii) Eighth Embodiment (Lever)

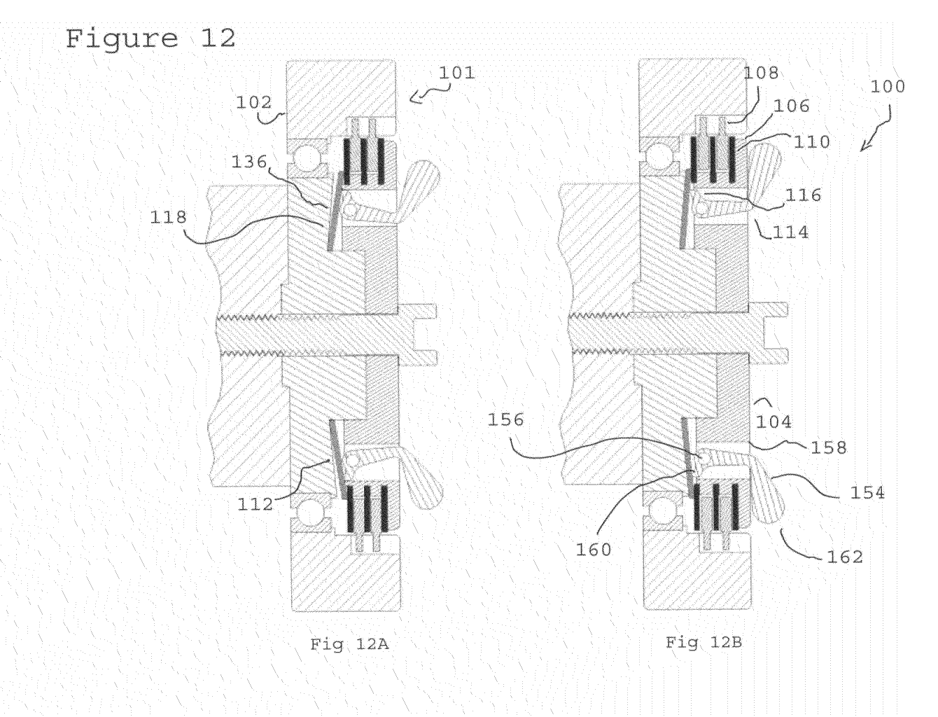

FIG. 12 shows an eighth embodiment of the variable mass flywheel 100 in accordance with aspects of the present invention.

In this embodiment, the coupler 112 includes an annular combination pressure-plate 118 and spring 136. The decoupler 116 includes a lever 154, as illustrated a class 1 lever, having a fulcrum 156 and pivotally mounted within a pocket 158 in the primary flywheel 102. The lever 154 has a load end 160 abutting the coupler 112 and an opposite weighted force end 162. As illustrated, the load end 160 is significantly closer to the fulcrum 156 than is the force end 162.

As the angular frequency of the variable mass flywheel 100 increases, the force end 162 of the lever 154 is urged radially outward from the axis of rotation of the variable mass flywheel 100. As the force end 162 of the lever 154 moves radially outward, the lever 154 pivots on the fulcrum 156 such that the load end 160 is urged against the combination pressure-plate 118 and spring 136. When the angular frequency of the variable mass flywheel 100 increases beyond the predetermined angular frequency, the lever 154 overcomes the combination pressure-plate 118 and spring 136, thereby allowing the friction disc 108 and the drive plate 110 to disengage and thus the primary flywheel 102 and the secondary flywheel to disengage. When the angular frequency of the variable mass flywheel 100 decreases below the predetermined angular frequency, the combination pressure-plate 118 and spring 136 overcomes the lever 154, thereby forcing the friction disc 108 and the drive plate 110 back into engagement and thus the primary flywheel 102 and the secondary flywheel back into engagement.

The predetermined angular frequency can be adjusted by adjusting the spatial and weight relationships in the lever 154 between the load end 160, the force end 162 and the fulcrum 156. Further adjustment can be effected by adjusting the spatial relationships between the lever 154 and the pocket 158 and the lever 154 and the combination pressure-plate 118 and spring 136. Additional adjustment can be effected by adjusting the strength of the combination pressure-plate 118 and spring 136.

### (c) Description Summary

Thus, it will be seen from the foregoing embodiments and examples that there has been described a way to provide a flywheel having mass that is a function of its angular frequency.

While specific embodiments of the invention have been described and illustrated, such embodiments should be considered illustrative of the invention only and not as limiting the invention as construed in accordance with the accompanying claims. In particular, any quantities described have been determined empirically and those skilled in the art might well expect a wide range of values surrounding those described to provide similarly beneficial results.

It will be understood by those skilled in the art that various changes, modifications and substitutions can be made to the foregoing embodiments without departing from the principle and scope of the invention expressed in the claims made herein.

I claim:

1. A variable mass flywheel apparatus, comprising:
a. a primary flywheel having an axis of rotation;
b. a secondary flywheel coaxial with the primary flywheel and having a mating portion that one of:
i. circumscribes the primary flywheel, and
ii. inscribes the primary flywheel;
c. a friction disc radiating from the primary flywheel;
d. a drive plate radiating from the mating portion of the secondary flywheel and lapping a portion of the friction disc;
e. a coupler urging the friction disc and the drive plate into abutment whereby the primary flywheel and the secondary flywheel are coupled for unified rotation;
f. a detector for detecting a condition that correlates with the desirability of the primary flywheel and the secondary flywheel being one of coupled and decoupled, the detector being operable to:
i. assume a first state when the condition is within a first range, and
ii. assume a second state when the condition is within a second range; and
g. a decoupler responsive to the state of the detector, operable when the detector is in the second state to overcome the coupler and urge the friction disc and the drive plate out of abutment whereby the primary flywheel and the secondary flywheel are decoupled for separate rotation.

2. An apparatus as claimed in claim 1, wherein the condition is the angular frequency of the primary flywheel, and the detector is operable to:
a. assume the first state when the angular frequency is less than a predetermined angular frequency, and
b. assume the second state when the angular frequency is greater than the predetermined angular frequency.

3. An apparatus as claimed in claim 2, wherein the friction disc and the drive plate are an interleaved plurality of friction discs and plurality of drive plates.

4. An apparatus as claimed in claim 3, wherein the coupler is a spring compressed between the primary flywheel and the friction disc.

5. An apparatus as claimed in claim 4, further including a pressure plate between the spring and the friction disc.

6. An apparatus as claimed in claim 5, wherein the detector includes:
a. a ramp radiating outward on the primary flywheel, the ramp having
i. a base, and
ii. an apex, the apex being radially farther than the base from the axis of rotation; and
b. a mass captive on the ramp and operable to move along the ramp between the base and the apex, wherein the mass:
i. moves proximate the base when the angular frequency of the primary flywheel is less than the predetermined angular frequency, whereby the detector assumes the first state, and
ii. moves proximate the apex when the angular frequency of the primary flywheel is greater than the predetermined angular frequency whereby the detector assumes the second state.

7. An apparatus as claimed in claim 6, wherein the decoupler includes:
a. a wedge radiating outward on the pressure plate and opposing the ramp, the wedge having
i. a toe, and
ii. a heel, the heel being radially farther than the toe from the axis of rotation,
the wedge sloping toward the ramp from toe to heel; and
b. a bearing circumscribing the mass and operable to move along the wedge between the toe and the heel as the mass moves along the ramp between the base and the apex, wherein the bearing:
i. moves proximate the toe when the detector assumes the first state, and
ii. moves proximate the heel when the detector assumes the second state, thereby bearing on the pressure plate to overcome the coupler and urge the friction disc and the drive plate out of abutment whereby the primary flywheel and the secondary flywheel are decoupled for separate rotation.

8. An apparatus as claimed in claim 7, wherein the mass is an axle having a first end and a second end.

9. An apparatus as claimed in claim 8, wherein the ramp is bifurcated by a channel into a first ramp and a second ramp, wherein the first end of the axle is captive on the first ramp and the second end of the axle is captive on the second ramp.

10. An apparatus as claimed in claim 9, wherein the channel receives the bearing.

11. An apparatus as claimed in claim 10, wherein the bearing is a rolling-element bearing.

12. An apparatus as claimed in claim 11, wherein the ramp slopes from the base to the apex toward the wedge.

13. An apparatus as claimed in claim 12, further including a plurality of the detector and a plurality of the decoupler distributed about the primary flywheel.

14. An actuator apparatus, comprising:
a. a body having an axis of rotation;
b. a pressure plate coaxial with the body;
c. a coupler urging the pressure plate toward the body;
d. a ramp radiating outward on the body, the ramp having
i. a base, and
ii. an apex, the apex being radially farther than the base from the axis of rotation;
e. a mass captive on the ramp and operable to move along the ramp between the base and the apex, wherein the mass:
i. moves proximate the base when the angular frequency of the body is less than a predetermined angular frequency, and
ii. moves proximate the apex when the angular frequency of the body is greater than the predetermined angular frequency;
f. a wedge radiating outward on the pressure plate and opposing the ramp, the wedge having
i. a toe, and
ii. a heel, the heel being radially farther than the toe from the axis of rotation,
the wedge sloping toward the ramp from toe to heel; and
g. a bearing circumscribing the mass and operable to move along the wedge between the toe and the heel as the mass moves along the ramp between the base and the apex, wherein the bearing at the heel bears upon the pressure plate to overcome the coupler and urge the pressure plate away from the body.

15. An apparatus as claimed in claim 14, wherein the mass is an axle having a first end and a second end.

16. An apparatus as claimed in claim 15, wherein the ramp is bifurcated by a channel into a first ramp and a second ramp, wherein the first end of the axle is captive on the first ramp and the second end of the axle is captive on the second ramp.

17. An apparatus as claimed in claim 16, wherein the channel receives the bearing.

18. An apparatus as claimed in claim 17, wherein the bearing is a rolling-element bearing.

19. An apparatus as claimed in claim 18, wherein the ramp slopes from the base to the apex toward the wedge.
